(19) United States
(12) Patent Application Publication
(10) Pub. No.: US 2025/0162818 A1
(43) Pub. Date: May 22, 2025

(54) PRODUCT PICKING DEVICE, PRODUCT ASSEMBLY DEVICE AND PRODUCT ASSEMBLY METHOD

(71) Applicants: TE Connectivity Solutions GmbH, Schaffhausen (CH); Tyco Electronics (Shanghai) Co., Ltd., Shanghai (CN)

(72) Inventors: Xianghao (Jorge) Bao, Shanghai (CN); Jian Cao, Shanghai (CN); Dandan (Emily) Zhang, Shanghai (CN); Sun Kyu Pak, Middletown, PA (US); Roberto Francisco-Yi Lu, Bellevue, WA (US); Mulang Song, Middletown, PA (US); Lvhai (Samuel) Hu, Shanghai (CN)

(73) Assignees: TE Connectivity Solutions GmbH, Schaffhausen (CH); Tyco Electronics (Shanghai) Co., Ltd., Shanghai (CN)

(21) Appl. No.: 18/952,438

(22) Filed: Nov. 19, 2024

(30) Foreign Application Priority Data
Nov. 21, 2023 (CN) 202311560244.0

(51) Int. Cl. B65G 47/90

(52) U.S. Cl. CPC B65G 47/90

(57) ABSTRACT

A product picking device includes a pair of picking claws adapted to pick up a product and place the picked-up product at a predetermined assembly position, and a pair of pressing claws. The pair of pressing claws are adapted to press on the product to maintain it at the predetermined assembly position. After the product is placed at the predetermined assembly position, the pair of pressing claws are adapted to hold the product at the predetermined assembly position until the pair of picking claws detach from the product.

### CROSS-REFERENCE TO RELATED APPLICATION

This application claims the benefit of Chinese Patent Application No. CN202311560244.0 filed on Nov. 21, 2023 in the State Intellectual Property Office of China, the whole disclosure of which is incorporated herein by reference.

### FIELD OF THE DISCLOSURE

The present disclosure relates to a product picking device, a product assembly device comprising the product picking device and a product assembly method.

### BACKGROUND OF THE INVENTION

In the prior art, in order to prevent dust, it is usually necessary to install an end cap on a port of the connector housing. In order to improve assembly efficiency, a robot equipped with a picking device is usually used to complete the assembly of the end cap. The picking device includes a pair of picking claws, which have protrusions suitable for insertion into the picking hole formed in the product. The protrusions of the pair of picking claws are suitable for being moved between the engagement position engaged with the inner wall surfaces of both ends of the picking hole and the release position separated from the inner wall surfaces of both ends of the picking hole.

After placing the picked-up product at the predetermined assembly position, the protrusions of the pair of picking claws are first moved to the release position, and then pulled out from the picking hole of the product. However, due to manufacturing errors, there may be interference fit between the protrusions of the picking claw and the inner wall surface of the picking hole. At this time, the product may be moved along with the protrusions of the picking claws, which can cause the product to deviate from its predetermined assembly position and even lead to product assembly failure, requiring reassembly. This will reduce the assembly accuracy and efficiency of the product.

### SUMMARY OF THE INVENTION

According to an embodiment of the present disclosure, a product picking device includes a pair of picking claws adapted to pick up a product and place the picked-up product at a predetermined assembly position, and a pair of pressing claws. The pair of pressing claws are adapted to press on the product to maintain it at the predetermined assembly position. After the product is placed at the predetermined assembly position, the pair of pressing claws are adapted to hold the product at the predetermined assembly position until the pair of picking claws detach from the product.

### BRIEF DESCRIPTION OF DRAWINGS

The accompanying drawings incorporated therein and forming a part of the specification illustrate the present disclosure and, and together with the description, further serve to explain the principles of the disclosure and to enable those skilled in the relevant art to manufacture and use the embodiments described herein.

FIG. 1 shows an illustrative perspective view of a product picking device according to an exemplary embodiment of the present invention;

FIG. 2 shows an illustrative perspective view of a product picking device according to an exemplary embodiment of the present invention when viewed from the bottom;

FIG. 3 shows an illustrative perspective view of a product picking device according to an exemplary embodiment of the present invention, in which the protrusion on the picking claw is inserted into the picking hole of the product and is in a release position that is not engaged with the picking hole;

FIG. 4 shows an illustrative perspective view of a product picking device according to an exemplary embodiment of the present invention, in which the protrusion on the picking claw is inserted into the picking hole of the product and in an engaged position with the picking hole;

FIG. 5 shows an illustrative perspective view of a product picking device according to an exemplary embodiment of the present invention, in which the product is placed at a predetermined assembly position and the pressing claw holds the product at the predetermined assembly position;

FIG. 6 shows an illustrative perspective view of a product picking device according to an exemplary embodiment of the present invention, in which the protrusion on the picking claw is pulled out from the picking hole of the product and the product is held at a predetermined assembly position by the pressing claw; and

FIG. 7 shows an illustrative view of a cylinder with a spring according to an exemplary embodiment of the present invention.

The features disclosed in this disclosure will become more apparent in the following detailed description in conjunction with the accompanying drawings, where similar reference numerals always identify the corresponding components. In the accompanying drawings, similar reference numerals typically represent identical, functionally similar, and/or structurally similar components. Unless otherwise stated, the drawings provided throughout the entire disclosure should not be construed as drawings drawn to scale.

### DETAILED DESCRIPTION

Exemplary embodiments of the present disclosure will be described hereinafter in detail with reference to the attached drawings, wherein the like reference numerals refer to the like elements. The present disclosure may, however, be embodied in many different forms and should not be construed as being limited to the embodiment set forth herein; rather, these embodiments are provided so that the present disclosure will be thorough and complete, and will fully convey the concept of the disclosure to those skilled in the art.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

According to an embodiment of the present disclosure, a product picking device includes a pair of picking claws for picking up a product and placing the picked-up product at a predetermined assembly position, and a pair of pressing claws for pressing on the product to keep it at the predetermined assembly position. After the product is placed at the predetermined assembly position, the pair of pressing claws hold the product at the predetermined assembly position until the pair of picking claws detach from the product.

According to another embodiment of the present disclosure, a product assembly device comprises the above product picking device, and a robot, wherein the product picking device is connected to a flange at an end of the robot. The robot picks up the product through the product picking device and places the picked-up product at a predetermined assembly position to complete the assembly operation of the product.

According to another embodiment of the present disclosure, a product assembly method comprises the steps of: providing the above product picking device or the above product assembly device; inserting the protrusions of the pair of picking claws of the product picking device into a picking hole of the product; moving the protrusions of the pair of picking claws to the engagement position engaged with the inner wall surfaces of both ends of the picking hole to pick up the product; placing the picked-up product at the predetermined assembly position; moving the pair of pressing claws of the product picking device to a pressing state in contact with the product, so as to press and hold the product at the predetermined assembly position through the pair of pressing claws; moving the protrusions of the pair of picking claws to the release position separated from the inner wall surfaces of both ends of the picking hole and pull out the protrusions of the pair of picking claws from the picking hole; and moving the pair of pressing claws to a retracted state separated from the product.

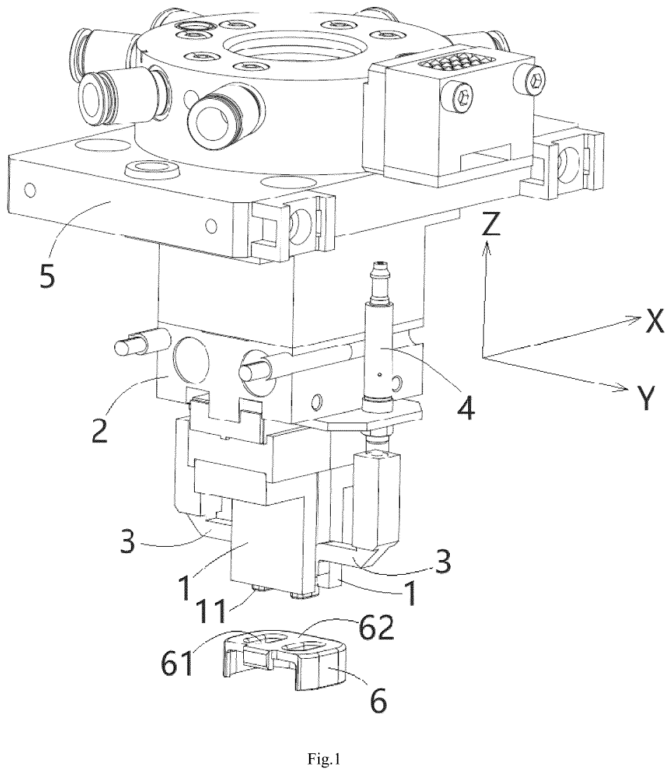

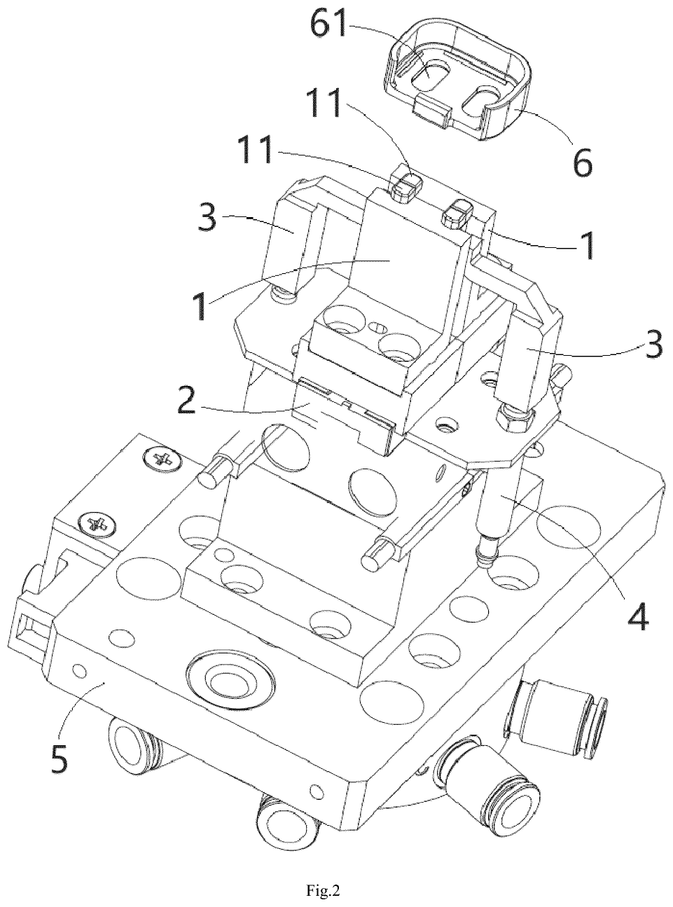

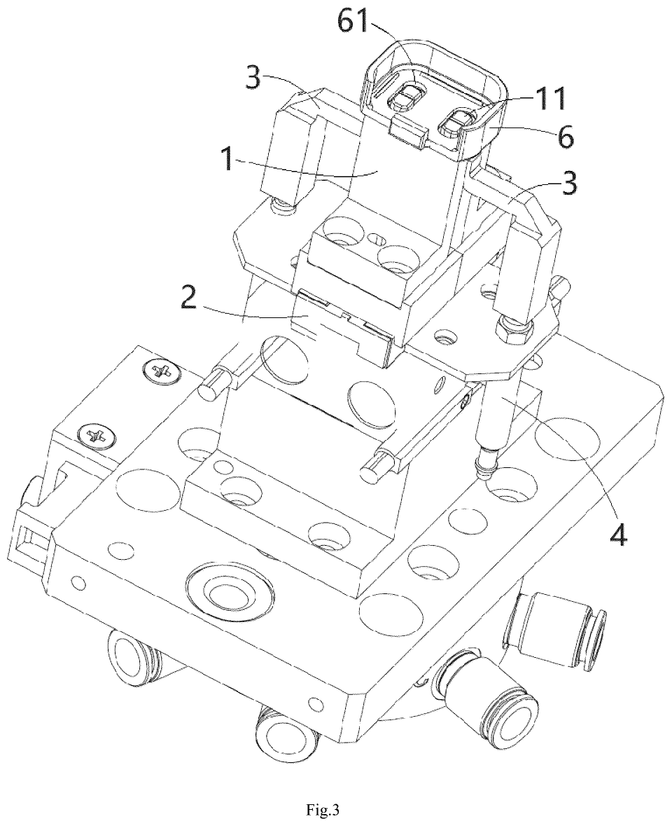

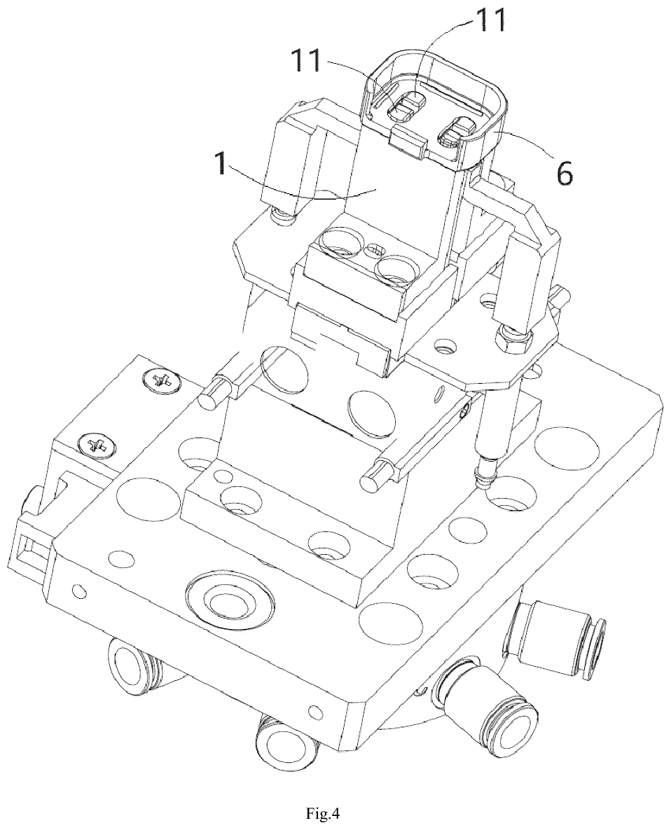

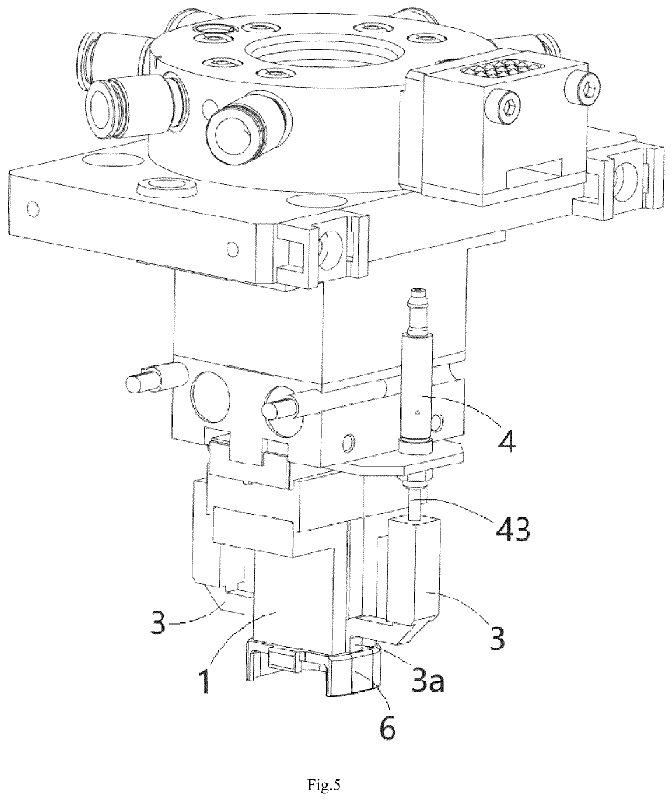

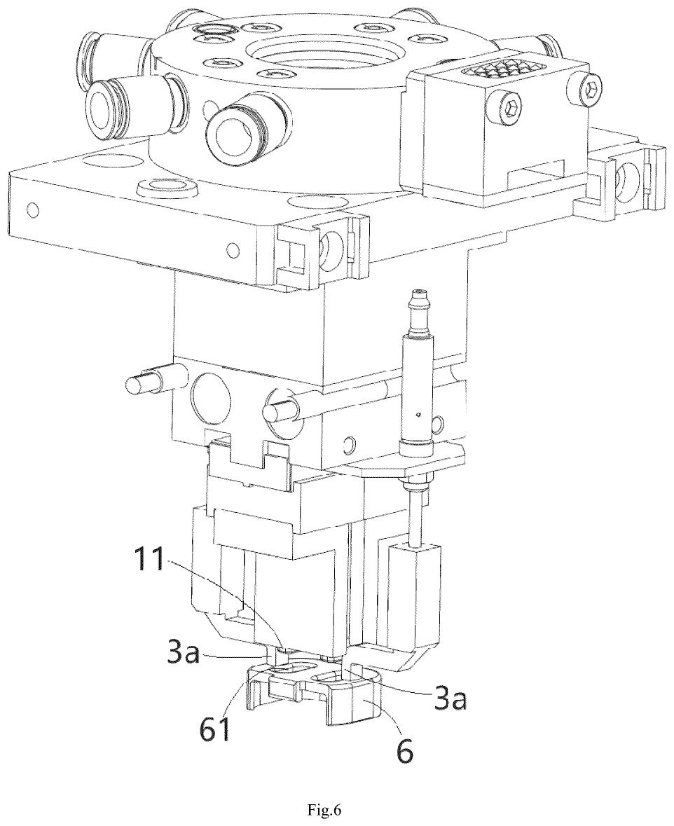

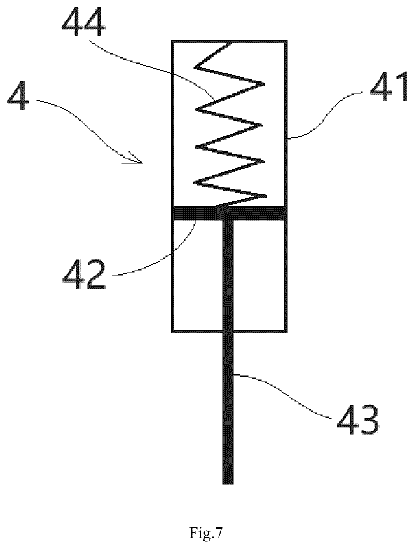

FIG. 1 shows an illustrative perspective view of a product picking device according to an exemplary embodiment of the present invention. FIG. 2 shows an illustrative perspective view of a product picking device according to an exemplary embodiment of the present invention when viewed from the bottom. FIG. 3 shows an illustrative perspective view of a product picking device according to an exemplary embodiment of the present invention, in which the protrusion 11 on the picking claw 1 is inserted into the picking hole 61 on the product 6 and is in a release position that is not engaged with the picking hole 61. FIG. 4 shows an illustrative perspective view of a product picking device according to an exemplary embodiment of the present invention, in which the protrusion 11 on the picking claw 1 is inserted into the picking hole 61 on the product 6 and is in an engaged position with the picking hole 61. FIG. 5 shows an illustrative perspective view of a product picking device according to an exemplary embodiment of the present invention, in which product 6 is placed at a predetermined assembly position and pressed by claw 3 to hold product 6 at the predetermined assembly position. FIG. 6 shows an illustrative perspective view of a product picking device according to an exemplary embodiment of the present invention, in which the protrusion 11 on the picking claw 1 is pulled out from the picking hole 61 of the product 6 and the product 6 is held at a predetermined assembly position by the pressing claw 3. FIG. 7 shows an illustrative view of a cylinder 4 with a spring 44 according to an exemplary embodiment of the present invention.

As shown in FIGS. 1-7, in an exemplary embodiment of the present invention, a product picking device is disclosed. The product picking device includes a pair of picking claws 1 and a pair of pressing claws 3. The pair of picking claws 1 are used to pick up a product 6 and place the picked-up product 6 at a predetermined assembly position. For example, the product 6 can be an end cap to be assembled onto a port of a connector housing (not shown), and the pair of picking claws 1 pick up the product 6 and assemble it onto the connector housing. The pair of pressing claws 3 are used to press on the product 6, so that the product 6 is held at the predetermined assembly position. In the illustrated embodiment, after the product 6 is placed at the predetermined assembly position, the pair of pressing claws 3 hold the product 6 at the predetermined assembly position until the pair of picking claws 1 detach from the product 6. In this way, it can effectively prevent the product from being moved with the picking claws after the product is placed at the predetermined assembly position, thereby improving the assembly accuracy and efficiency of the product.

In the illustrated embodiment, the picking claw 1 has a protrusion 11 adapted to be inserted into the picking hole 61 formed in the product 6, and the protrusions 11 of the pair of picking claws 1 are adapted to be moved between an engagement position engaged with the inner wall surfaces of both ends of the picking hole 61 and a release position separated from the inner wall surfaces of both ends of the picking hole 61. After the product 6 is placed at the predetermined assembly position, the pair of pressing claws 3 hold the product 6 at the predetermined assembly position until the protrusions 11 of the pair of picking claws 1 are pulled out from the picking hole 61 of the product 6.

The protrusion 11 has a semi-circular outer peripheral surface, and the end of the picking hole 61 has a semi-circular inner peripheral surface. The semi-circular outer peripheral surface of the protrusion 11 is used to engage with the semi-circular inner peripheral surface of the end of the picking hole 61 to pick up and position the product 6.

The product picking device further comprises a driving device 2, which is connected to the pair of picking claws 1 and used to drive the protrusions 11 of the pair of picking claws 1 to move along the first horizontal direction X between the engagement position and the release position. In an exemplary embodiment of the present invention, the driving device 2 can be a cylinder, a hydraulic cylinder, or an electric motor.

The pair of picking claws 1 have opposite left and right sides in the second horizontal direction Y perpendicular to the first horizontal direction X, and the pair of pressing claws 3 are located at the left and right sides of the pair of picking claws 1, respectively. Vertical grooves 101 are respectively formed on the left and right sides of the pair of picking claws 1, allowing the pressing claw 3 to move in the vertical direction Z. The end portion 3a of the pressing claw 3 is located in the vertical groove 101 and is adapted to move along the vertical groove 101, so as to be able to rest on the outer wall surface 62 of the product 6.

In one embodiment, the product picking device further comprises a pair of drivers 4, which are respectively connected to the pair of pressing claws 3 for driving the pair of pressing claws 3 to move between a pressing state in contact with the product 6 and a retracted state separated from the product 6. The driver 4 can be, for example, the cylinder shown in FIG. 7, which includes a cylinder body 41, a piston 42, a piston rod 43, and a spring 44. The piston 42 and spring 44 are arranged in the cylinder body 41, and the spring 44 is compressed between the inner wall of the cylinder body 41 and the piston 42. The piston rod 43 extends from the cylinder body 41 and is connected to the pressing claw 3. When the pressing claw 3 is pressed against the product 6, the spring 44 applies a predetermined pressing force on the product 6, thereby reliably holding the product 6 at the predetermined assembly position.

The product picking device further comprises an installation seat 5 for mounting and fixing the driving device 2 and the driving device 4. The installation seat 5 is suitable for being connected to the flange at the end of the robot to enable the product picking device to be connected to the robot.

In another exemplary embodiment of the present invention, a product assembly device is also disclosed. The product assembly device includes the aforementioned product picking device and a robot (not shown), and the product picking device is connected to the flange at the end of the robot. The robot picks up the product 6 through the product picking device and places the picked-up product 6 at the predetermined assembly position.

In another exemplary embodiment of the present invention, a product assembly method is also disclosed. The assembly method of this product includes the following steps of:
S10: Providing the aforementioned product picking device or the product assembly device;
S20: Inserting the protrusions 11 of the pair of picking claws 1 of the product picking device into the picking holes 61 of the product 6;
S30: Moving the protrusions 11 of the pair of picking claws 1 to the engagement position engaged with the inner wall surfaces of both ends of the picking hole 61 to pick up the product 6;
S40: Placing the picked-up product 6 at the predetermined assembly position;
S50: Moving the pair of pressing claws 3 of the product picking device to a pressing state in contact with the product 6, so as to press and hold the product 6 at the predetermined assembly position through the pair of pressing claws 3;
S60: Moving the protrusions 11 of the pair of picking claws 1 to the release position separated from the inner wall surfaces of both ends of the picking hole 61 and pull out the protrusions 11 of the pair of picking claws 1 from the picking hole 61; and
S70: Moving the pair of pressing claws 3 to the retracted state separated from product 6.

It should be appreciated for those skilled in this art that the above embodiments are intended to be illustrated, and not restrictive. For example, many modifications may be made to the above embodiments by those skilled in this art, and various features described in different embodiments may be freely combined with each other without conflicting in configuration or principle.

Although several exemplary embodiments have been shown and described, it would be appreciated by those skilled in the art that various changes or modifications may be made in these embodiments without departing from the principles and spirit of the disclosure, the scope of which is defined in the claims and their equivalents.

As used herein, an element recited in the singular and proceeded with the word “a” or “an” should be understood as not excluding plural of said elements or steps, unless such exclusion is explicitly stated. Furthermore, references to “one embodiment” of the present invention are not intended to be interpreted as excluding the existence of additional embodiments that also incorporate the recited features. Moreover, unless explicitly stated to the contrary, embodiments “comprising” or “having” an element or a plurality of elements having a particular property may include additional such elements not having that property.

1. A product picking device, comprising:
a pair of picking claws adapted to pick up a product and place the picked-up product at a predetermined assembly position; and
a pair of pressing claws adapted to press on the product to maintain it at the predetermined assembly position, wherein after the product is placed at the predetermined assembly position, the pair of pressing claws are adapted to hold the product at the predetermined assembly position until the pair of picking claws detach from the product.

2. The product picking device according to claim 1, wherein the picking claw includes a protrusion adapted to be inserted into a picking hole formed in the product.

3. The product picking device according to claim 2, wherein and the protrusions of the pair of picking claws are adapted to be moved between an engagement position engaged with inner wall surfaces of each end of the picking hole and a release position separated from the inner wall surfaces of each end of the picking hole.

4. The product picking device according to claim 3, wherein after the product is placed at the predetermined assembly position, the pair of pressing claws hold the product at the predetermined assembly position until the protrusions of the pair of picking claws are pulled out from the picking hole of the product.

5. The product picking device according to claim 4, wherein the protrusion has a semi-circular outer peripheral surface, and the end of the picking hole has a semi-circular inner peripheral surface.

6. The product picking device according to claim 5, wherein the semi-circular outer peripheral surface of the protrusion is adapted to engage with the semi-circular inner peripheral surface of the end of the picking hole to pick up and position the product.

7. The product picking device according to claim 4, further comprising a driving device connected to the pair of picking claws and adapted to drive the protrusions of the pair of picking claws to move along a first horizontal direction between the engagement position and the release position.

8. The product picking device according to claim 7, wherein the driving device is a cylinder, a hydraulic cylinder, or a motor.

9. The product picking device according to claim 7, wherein the pair of picking claws have opposite left and right sides in a second horizontal direction perpendicular to the first horizontal direction, and the pair of pressing claws are arranged at the left and right sides of the pair of picking claws, respectively.

10. The product picking device according to claim 9, wherein vertical grooves are respectively formed on the left and right sides of the pair of picking claws to allow the pressing claw to move in the vertical direction.

11. The product picking device according to claim 10, wherein an end portion of the pressing claw is located in the vertical groove and is adapted to move along the vertical groove to be able to rest on an outer wall surface of the product.

12. The product picking device according to claim 7, further comprising a pair of drivers respectively connected to the pair of pressing claws, and adapted to drive the pair of pressing claws to move between a pressing state in contact with the product and a retracted state separated from the product.

13. The product picking device according to claim 12, wherein each driver is a cylinder including a cylinder body, a piston, a piston rod, and a spring.

14. The product picking device according to claim 13, wherein:
the piston and the spring are arranged in the cylinder body;
the spring is compressed between the inner wall of the cylinder body and the piston; and
the piston rod extends from the cylinder body and is connected to the pressing claw.

15. The product picking device according to claim 14, wherein when the pressing claw is pressed against the product, the spring applies a predetermined pressing force on the product.

16. The product picking device according to claim 15, further comprising an installation seat for installing and fixing the driving device and the driver, the installation seat being connected to a flange at an end of a robot, so as to be able to connect the product picking device to the robot.

17. A product assembly device, comprising:
the product picking device according to claim 1; and
a robot, wherein:
the product picking device is connected to a flange at an end of the robot; and
the robot picks up the product through the product picking device and places the picked-up product at a predetermined assembly position to complete the assembly operation of the product.

18. The product assembly device according to claim 17, wherein the picking claw includes a protrusion adapted to be inserted into a picking hole formed in the product.

19. The product assembly device according to claim 18, wherein and the protrusions of the pair of picking claws are adapted to be moved between an engagement position engaged with inner wall surfaces of each end of the picking hole and a release position separated from the inner wall surfaces of each end of the picking hole.

20. The product assembly device according to claim 19, wherein after the product is placed at the predetermined assembly position, the pair of pressing claws hold the product at the predetermined assembly position until the protrusions of the pair of picking claws are pulled out from the picking hole of the product.

21. A product assembly method, comprising the steps of:
providing the product picking device according to claim 1 or the product assembly device according to claim 17;
inserting the protrusions of the pair of picking claws of the product picking device into a picking hole of the product;
moving the protrusions of the pair of picking claws to the engagement position engaged with the inner wall surfaces of both ends of the picking hole to pick up the product;
placing the picked-up product at the predetermined assembly position;
moving the pair of pressing claws of the product picking device to a pressing state in contact with the product, so as to press and hold the product at the predetermined assembly position through the pair of pressing claws;
moving the protrusions of the pair of picking claws to the release position separated from the inner wall surfaces of both ends of the picking hole and pull out the protrusions of the pair of picking claws from the picking hole; and
moving the pair of pressing claws to a retracted state separated from the product.
